(19) United States
(12) Patent Application Publication
(10) Pub. No.: US 2024/0174263 A1
(43) Pub. Date: May 30, 2024

(54) VEHICLE CONTROL SYSTEM

(71) Applicant: TOYOTA JIDOSHA KABUSHIKI KAISHA, Toyota-shi (JP)

(72) Inventors: Sho HASHIMOTO, Susono-shi (JP); Satoshi NAKAMURA, Sunto-gun (JP); Sei MIYAZAKI, Susono-shi (JP); Kazunori NAKANO, Fujinomiya-shi (JP); Noriaki HASEGAWA, Izunokuni-shi (JP)

(73) Assignee: TOYOTA JIDOSHA KABUSHIKI KAISHA, Toyota-shi (JP)

(21) Appl. No.: 18/470,651

(22) Filed: Sep. 20, 2023

(30) Foreign Application Priority Data
Nov. 24, 2022 (JP) 2022-187705

(51) Int. Cl. B60W 60/00; B60Q 11/00

(52) U.S. Cl. CPC B60W 60/00186; B60Q 11/005; B60W 2554/20

(57) ABSTRACT

The present disclosure relates to a vehicle control system. The vehicle control system includes an autonomous driving control system that controls autonomous driving of the vehicle, and a safety control system that communicates with the autonomous driving control system and stops the vehicle when the autonomous driving control system fails or when communication is abnormal. The safety control system notifies the autonomous driving control system of the contents of the failure when a failure of a part of the function of the safety control system occurs. The autonomous driving control system sets a traveling route to a destination during the autonomous driving in accordance with the contents of the failure.

### CROSS-REFERENCE TO RELATED APPLICATION

This application claims priority to Japanese Patent Application No. 2022-187705 filed on Nov. 24, 2022, incorporated herein by reference in its entirety.

### BACKGROUND

### 1. Technical Field

The present disclosure relates to a vehicle control system for controlling an autonomous driving vehicle.

### 2. Description of Related Art

Japanese Unexamined Patent Application Publication No. 2021-111098 (JP 2021-111098 A) discloses a travel assistance control device that assists the travel of an autonomous driving vehicle. When an abnormality occurs in a vehicle-mounted sensor necessary for autonomous driving, the travel assistance control device avoids an unexpected situation such as an accident by a stop mode, an avoidance mode, or a reduced travel mode. In the stop mode, the vehicle is immediately stopped. In the avoidance mode, the vehicle is evacuated from the site to a safe location and stopped. In the reduced travel mode, the autonomous driving of the vehicle is restricted.

### SUMMARY

There is known a safety control system for stopping a vehicle in order to avoid an unexpected situation when an autonomous driving control system for controlling autonomous driving of the vehicle has some trouble. In such a system, the control of the vehicle in the case where an abnormality occurs in the autonomous driving control system has been studied, but there is room for studying the control of the vehicle in the case where an abnormality occurs in the safety control system itself. It is an object of the present disclosure to provide a technique capable of achieving both safety and continuity of autonomous driving in a case where an abnormality occurs in a part of a function of a safety control system.

The present disclosure relates to a vehicle control system. The vehicle control system includes: an autonomous driving control system for controlling autonomous driving of a vehicle; and a safety control system for performing communication with the autonomous driving control system and stopping the vehicle at a time of failure of the autonomous driving control system or at a time of abnormality of the communication. When a failure of a part of a function of the safety control system occurs, the safety control system notifies the autonomous driving control system of a content of the failure. The autonomous driving control system sets a travel route to a destination during the autonomous driving in accordance with the content of the failure.

According to the present disclosure, when an abnormality occurs in a part of a function of the safety control system, it is possible to achieve both safety and continuity of autonomous driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of a vehicle control system according to the present embodiment;

FIG. 2 is a block diagram illustrating an example of a functional configuration of the vehicle control system according to the present embodiment;

FIG. 3A is a conceptual diagram illustrating an exemplary hazard map;

FIG. 3B is a conceptual diagram illustrating an exemplary setting of a travel route based on a hazard map;

FIG. 4 is a flow chart illustrating an exemplary process executed by the safety control system according to the present embodiment; and

FIG. 5 is a flowchart illustrating an example of processing executed by the autonomous driving control system according to the present embodiment.

### DETAILED DESCRIPTION OF EMBODIMENTS

Embodiments of the present disclosure will be described with reference to the accompanying drawings.

### 1. Configuration of Vehicle Control System

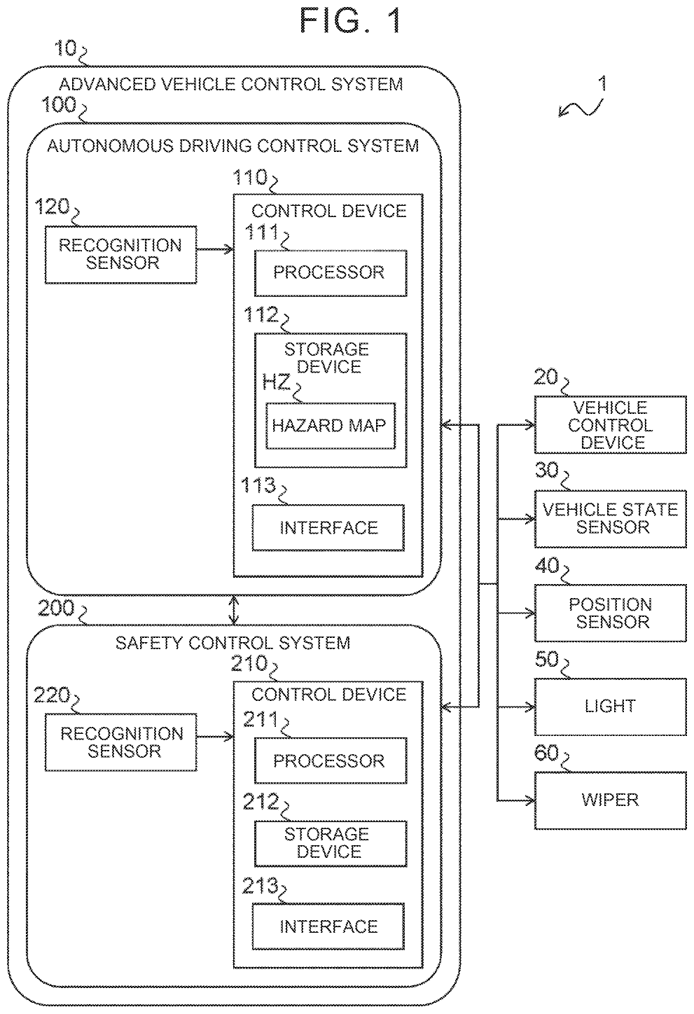

FIG. 1 is a diagram illustrating an example of a configuration of a vehicle control system 10 according to the present embodiment. The vehicle control system 10 includes an autonomous driving control system 100 and a safety control system 200. Typically, the vehicle control system 10 is mounted on the vehicle 1. Alternatively, a part of the vehicle control system 10 may be disposed in an external device outside the vehicle 1 and remotely control the vehicle 1. That is, the vehicle control system 10 may be distributed between the vehicle 1 and the external device.

The autonomous driving control system 100 controls autonomous driving of the vehicle 1. The autonomous driving control system 100 includes a recognition sensor 120 and a control device 110.

The recognition sensor 120 is mounted on the vehicle 1 and recognizes (detects) a situation around the vehicle 1. Recognition sensors 120 include LIDAR and cameras. The recognition sensor 120 may include other sensors, such as a radar or a sonar.

The control device 110 includes at least one processor 111, at least one storage device 112, and an interface 113. The storage device 112 stores various data including map information and various programs. The map data stored in the storage device 112 includes hazard map HZ. The hazard map HZ will be described later. By the processor 111 reading and executing the program from the storage device 112, various functions of the autonomous driving control system 100 including the control of the autonomous driving of the vehicle 1 are realized. The control device 110 can communicate with the recognition sensor 120 and an external device of the autonomous driving control system 100 via the interface 113. The communication destination of the control device 110 may include a management server outside the vehicle 1. In this case, the control device 110 may acquire information from the management server and update the map information stored in the storage device 112 as needed.

The safety control system 200 is a system for stopping the vehicle 1 in order to avoid an unexpected situation when it is determined that it is difficult for the autonomous driving control system 100 to continue the autonomous driving. The safety control system 200 communicates with the autonomous driving control system 100 at least during autonomous driving of the vehicle 1. When an abnormality occurs in communication with the autonomous driving control system 100 or when the autonomous driving control system 100 fails, the safety control system 200 controls the vehicle 1 to stop. Typically, the safety control system 200 retracts and stops the vehicle 1 to a safe location, such as a road shoulder, while slowly decelerating the vehicle. Alternatively, in a situation where it is determined that the emergency is high, the safety control system 200 may immediately stop the vehicle 1. The safety control system 200 includes a recognition sensor 220 and a control device 210.

The recognition sensor 220 is mounted on the vehicle 1 and recognizes (detects) a situation around the vehicle. Recognition sensors 220 include LIDAR and cameras. The recognition sensor 220 may include other sensors, such as a radar or a sonar. The recognition sensor 220 is a sensor of the safety control system 200 different from the recognition sensor 120 of the autonomous driving control system 100.

The control device 210 includes at least one processor 211, at least one storage device 212, and an interface 213. The storage device 212 stores various data and various programs. The processor 211 reads the program from the storage device 212 and executes the program, thereby realizing various functions of the safety control system 200. The control device 210 can communicate with the recognition sensor 220 and a device external to the safety control system 200 via the interface 213.

The autonomous driving control system 100 and the safety control system 200 communicate with each unit of the vehicle 1. The communication destination of the autonomous driving control system 100 includes a vehicle control device 20, a vehicle state sensor 30, a position sensor 40, a light 50, and a wiper 60. The communication destination of the safety control system 200 includes at least the vehicle control device 20. The safety control system 200 may also communicate with the vehicle state sensor 30, the light 50, and the wiper 60.

The vehicle control device 20 can control steering, acceleration, and deceleration of the vehicle 1 by operating an actuator of the vehicle 1. The autonomous driving control system 100 and the safety control system 200 can control the vehicle 1 by communicating with the vehicle control device 20.

The vehicle state sensor 30 detects the state of the vehicle 1. The vehicle state sensor includes a speed sensor, an acceleration sensor, a yaw rate sensor, a steering angle sensor, and the like. The autonomous driving control system 100 can acquire information about the state of the vehicle 1 by communicating with the vehicle state sensor 30.

The position sensor 40 detects the position and the azimuth of the vehicle 1. As the position sensor 40, a Global Positioning System (GPS) sensor is exemplified. The autonomous driving control system 100 can acquire the position information of the vehicle 1 by communicating with the position sensor 40.

### 2. Functions of Autonomous Driving Control System and Safety Control System

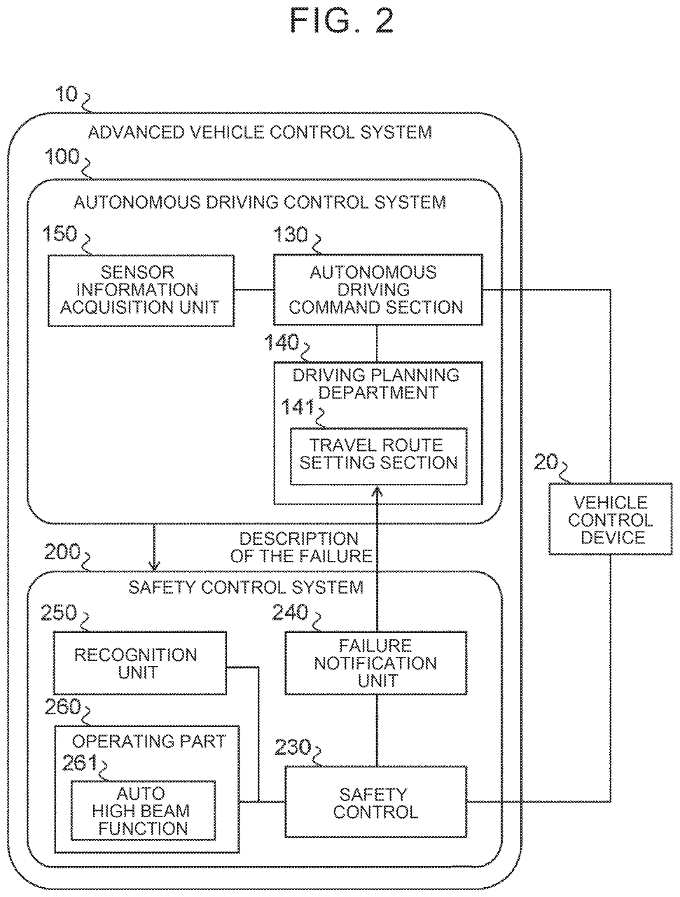

FIG. 2 is a diagram illustrating an example of a functional configuration of the autonomous driving control system 100 and the safety control system 200.

The autonomous driving control system 100 includes an autonomous driving command unit 130, a travel planning unit 140, and a sensor information acquisition unit 150 as functional units. These functional units of the autonomous driving control system 100 correspond to a blog or a part thereof stored in the storage device 112. These functional units are realized by the program being read from the storage device 112 and executed by the processor 111.

In autonomous driving of the vehicle 1 by the autonomous driving control system 100, first, a traveling plan of the vehicle 1 is created by the travel planning unit 140. The creation of the travel plan by the travel planning unit 140 includes acquisition of the current location of the vehicle 1 and determination of the destination. The travel planning unit 140 can acquire the current position of the vehicle 1 from the position sensor 40. The destination of the vehicle 1 is stored in the storage device 112 as map information. Alternatively, the destination may be acquired by communication with the management server.

The travel planning unit 140 includes a travel route setting unit 141. The travel route setting unit 141 sets a traveling route from the current position during the autonomous driving of the vehicle 1 to the destination based on the map information stored in the storage device 112. The set travel route is temporarily stored in the storage device 112. In addition, when some functions of the safety control system 200 fail, the travel route setting unit 141 sets a travel route in accordance with the contents of the failure. The traveling route corresponding to the contents of the failure will be described later. The travel route set by the travel route setting unit 141 is input to the autonomous driving command unit 130.

The sensor information acquisition unit 150 acquires sensor information from the recognition sensor 120, the vehicle state sensor 30, and the position sensor 40. The sensor information is input to the autonomous driving command unit 130. The autonomous driving command unit 130 calculates a target trajectory of the vehicle 1 for traveling in accordance with the traveling route based on the sensor information. The target trajectory includes a target position and a target speed of the vehicle 1 in a road on which the vehicle 1 travels. The target speed may be set for each target position. The autonomous driving command unit 130 controls the vehicle 1 to follow the calculated target trajectory via the vehicle control device 20. Thus, the autonomous driving of the vehicle 1 is performed.

The safety control system 200 includes a safety control unit 230, a failure notification unit 240, a recognition unit 250, and an operation unit 260 as functional units. These functional units of the safety control system 200 correspond to the programs or portions thereof stored in the storage device 212. These functional units are realized by the program being read from the storage device 212 and executed by the processor 211.

The safety control unit 230 performs safety control for stopping the vehicle 1 when it is determined that it is difficult for the autonomous driving control system 100 to continue the autonomous driving. The safety control unit 230 can determine that it is difficult for the autonomous driving control system 100 to continue the autonomous driving, for example, in the following manner. For example, when the self-diagnosis function of the autonomous driving control system 100 detects a failure (abnormality) of the autonomous driving control system 100, the autonomous driving control system 100 notifies the safety control system 200 that an abnormality has occurred. The safety control system 200 can determine that it is difficult to continue the autonomous driving by the notification. As another example, when communication with the autonomous driving control system 100 is interrupted and a signal is not received from the autonomous driving control system 100, the safety control system 200 determines that it is difficult to continue the autonomous driving.

When the safety control by the safety control unit 230 is performed, the recognition unit 250 recognizes the surroundings of the vehicle 1 by the recognition sensor 220 and acquires the recognition information. The recognition information includes information about a target around the vehicle 1. The recognition information is input to the safety control unit 230, and the safety control unit 230 can control the vehicle 1 based on the recognition information.

In addition, the operation unit 260 may operate a device such as the light 50 or the wiper 60 so that the safety control unit 230 can obtain sufficient recognition information. For example, the operation unit 260 includes an auto high beam function 261. When the brightness of the surroundings of the vehicle 1 is insufficient and the required recognition data cannot be sufficiently obtained from the recognition sensor 220, the high beam of the light 50 is turned ON by the auto high beam function 261, and the surroundings of the vehicle 1 are brightened. Alternatively, the operation unit 260 may include a function of operating the wiper 60. For example, when sufficient information cannot be obtained from the recognition sensor 220 because the window glass in front of the recognition sensor 220 has water droplets, the operation unit 260 can wipe the water droplets by operating the wiper 60.

The failure notification unit 240 detects a failure of a part of the function of the safety control system 200. The failure detected by the failure notification unit 240 includes a failure of the auto-high beam function 261, a sensor temperature abnormality, and a failure related to a recognition system of the safety control system 200. The failure detected by the failure notification unit 240 may include, in addition, a failure of the operation function of the wiper 60 of the operation unit 260.

The sensor temperature abnormality is that the recognition sensor 220 becomes higher than a predetermined temperature. This is caused by, for example, exposure of the vehicle 1 and the recognition sensor 220 to direct sunlight for a long time, a sudden increase in the temperature around the vehicle 1, and a sudden increase in the processing load of the recognition sensor 220. The predetermined temperature may be, for example, an upper limit of an operating temperature range of the recognition sensor 220. A failure related to the recognition system of the safety control system 200 refers to a failure of the recognition sensor 220, a failure of the recognition unit 250, or a communication failure between the recognition sensor 220 and the control device 210.

When a failure occurs in a part of the functions of the safety control system 200, the failure notification unit 240 notifies the travel route setting unit 141 of the details of the failure.

### 3. Hazard Map

The travel route setting unit 141 sets the traveling route of the vehicle 1 according to the contents of the failure when the failure notification unit 240 notifies the contents of the failure. The travel route setting according to the content of the failure is performed based on the hazard map HZ.

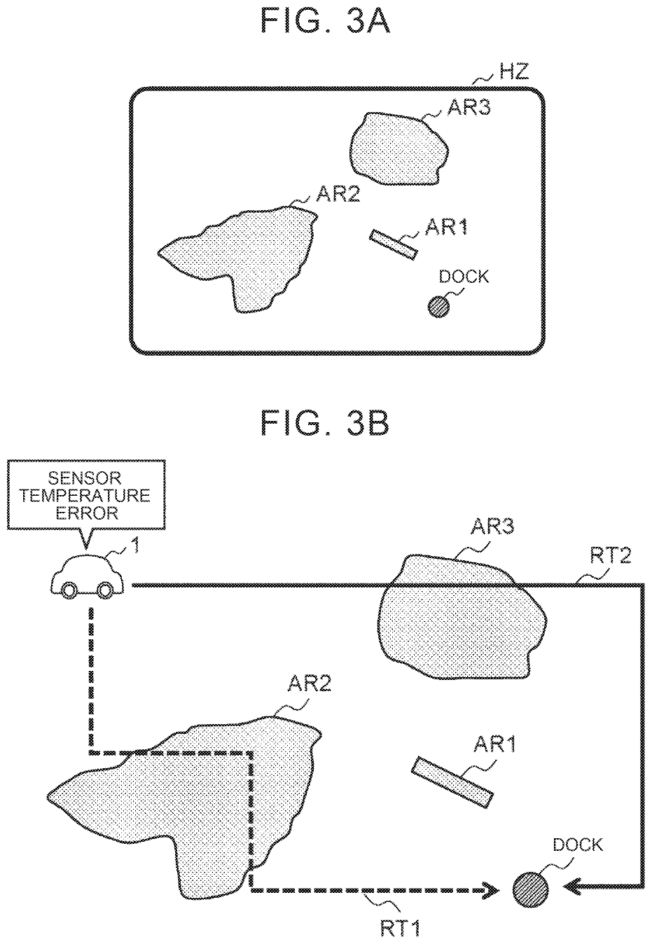

FIG. 3A is a conceptual diagram illustrating an exemplary hazard map HZ. The hazard map HZ is map information indicating an avoidance area to be avoided for each failure content, and is stored in the storage device 112. The hazard map HZ is stored in advance in the storage device 112. Alternatively, the hazard map HZ may be updated in real time by the management server, and the autonomous driving control system 100 may obtain hazard map HZ from the management server at any time. In the hazard map HZ of FIG. 3A, three avoidance-area AR1, AR2, AR3 are shown. The dock is a storage location of the vehicle 1 and is a destination of the vehicle 1.

The avoidance-area AR1 is in the dark. Here, the dark place refers to an area in which the average brightness obtained by averaging the brightness in the area is less than the threshold value. Examples of dark places include tunnels and mountain paths. Dark is an avoidance area for the failure of the auto high beam function 261.

The avoidance area AR2 is a thermal attention area. The temperature attention region is a region in which the vehicle 1 may be exposed to direct sunlight for a long time. The temperature attention region is, for example, an area in which neither a building nor a natural object having a predetermined height or more that blocks the sunlight exists. The temperature attention area is an avoidance area for a sensor temperature abnormality.

The avoidance-area AR3 is a densely populated area. The densely populated area is an area in which the population density in the area is equal to or greater than a threshold value. The densely populated area is an area of avoidance for a failure related to a recognition system of the safety control system 200.

The hazard map HZ may indicate avoidance areas other than the three types of avoidance areas. For example, the hazard map HZ may indicate an area in which the mean rainfall from the present time to a predetermined time after the lapse of time is predicted to be larger than the threshold value as an area for avoiding failure of the operating function of the wiper 60. This avoidance area is an example when the hazard map HZ is updated in real time.

FIG. 3B shows an exemplary setting of a travel route based on the hazard map HZ shown in FIG. 3A. The travel route setting unit 141 sets the traveling route to the destination so as to avoid the avoidance area corresponding to the content of the failure on the basis of the content of the failure notified from the failure notification unit 240 and the hazard map HZ. It should be noted that setting the travel route so as to avoid the avoidance area includes changing the travel route already set.

Here, the content of the failure is a sensor temperature abnormality. In addition, the predetermined travel route RT1 that is set prior to the notification of the content of the failure passes through the avoidance-area AR2 for the sensor temperature anomaly. Therefore, the travel route setting unit 141 sets the travel route RT2 so as to avoid the avoidance-area AR2. That is, the travel route RT1 is changed to the travel route RT2.

An effect of setting a travel route according to the contents of the failure will be described. When a failure occurs in some functions of the safety control system 200, the autonomous driving control system 100 functions normally. Basically, the vehicle 1 safely reaches the destination by the autonomous driving control performed by the autonomous driving control system 100. However, if the autonomous driving control system 100 fails, the safety control system 200 performs safety control for safely stopping the vehicle 1. In this case, the travel route is set so that the safety control can be performed with as high an accuracy as possible even in the case of the safety control system 200 in which some functions have failed.

For example, in a case where the auto-high beam function 261 fails, a travel route is set so as to avoid a dark place. Therefore, the autonomous driving control system 100 does not fail in the dark, and as a result, a situation in which the safety control system 200 in which the auto-high beam function 261 fails must operate in the dark is also avoided. That is, safety is ensured.

As another example, if there is a sensor temperature abnormality, the travel route is set so as to avoid the temperature attention area. As a result, it is possible to avoid a situation in which the recognition sensor 220 having a high temperature continues to be exposed to direct sunlight for a long time and the temperature rises thereafter. Excessive temperature rise can reduce the likelihood that the recognition sensor 220 will not operate.

As a comparative example, consider that the vehicle 1 is unconditionally stopped and the autonomous driving is terminated at a stage when a failure occurs in some functions of the safety control system 200. In this case, the automatic operation ends even though the autonomous driving control system 100 is still functioning normally. That is, the comparative example is excessively pessimistic, and the continuity of the autonomous driving is reduced. On the other hand, according to the present embodiment, at a stage when a failure occurs in some functions of the safety control system 200, only the travel route is set so as to ensure safety, and the autonomous driving does not immediately end. Therefore, it is possible to ensure the continuity of the autonomous driving while securing the safety.

In addition, setting the travel route according to the content of the failure is effective in reducing the influence on the autonomous driving control system 100. For example, if a sensor temperature abnormality occurs, there is a possibility that the temperature of the entire vehicle 1 is rising. Therefore, if the vehicle 1 continues to travel in an area exposed to direct sunlight thereafter, the temperature of the in-vehicle sensors such as the recognition sensor 120, the vehicle state sensor 30, and the position sensor 40 other than the recognition sensor 220 may also increase. In the present embodiment, the traveling route is set so as to avoid the temperature attention region, so that the influence on the sensor used by the autonomous driving control system 100 can also be reduced. As described above, by the vehicle control system 10 according to the present embodiment, it is possible to reduce the influence on the control of the vehicle 1 and to continue the autonomous driving while maintaining the safety.

When the predetermined traveling route does not pass through the avoidance area for the contents of the failure, the travel route setting unit 141 may set the predetermined traveling route as the traveling route corresponding to the contents of the failure as it is. In addition, the hazard map HZ may include, in addition to the avoidance area, information about a priority area in which it is desired to preferentially travel. When there is a plurality of candidates for a traveling route that avoids the avoidance area for the contents of the failure, the traveling route that passes through the priority area is preferentially set. For example, for the sensor temperature abnormality, an area where there are many street trees that block direct sunlight may be set as the priority area. In this case, it is possible to increase the possibility that the temperature of the recognition sensor 120 or the vehicle 1 can be prevented from rising by preferentially selecting an area with a large shade of trees.

### 4. Process Flow

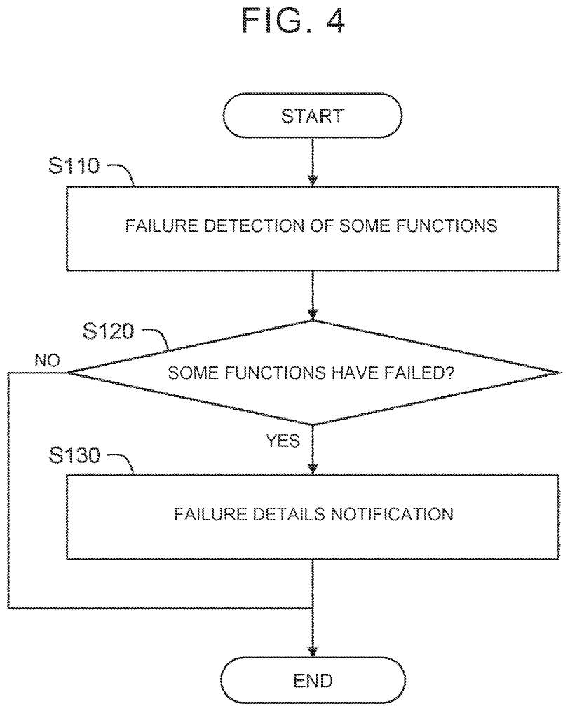

An example of the flow of processing related to the setting of the traveling route according to the contents of the failure performed by the autonomous driving control system 100 and the safety control system 200 will be described. FIG. 4 is a flowchart illustrating an example of processing performed by the failure notification unit 240 of the safety control system 200. The process illustrated in FIG. 4 is repeatedly executed in a predetermined control cycle. This processing is realized by the processor 211 executing a program stored in the storage device 212.

In S110, the processor 211 detects failure of some functions of the safety control system 200. When a fault is detected, the process proceeds to S120.

In S120, the processor 211 determines whether a failure of some functions of the safety control system 200 has been detected. If a fault is detected (S120; Yes), the process proceeds to S130. On the other hand, if no fault is detected (S120; No), the process in the present cycling ends.

In S130, the processor 211 notifies the autonomous driving control system 100 of the content of the fault detected in S110. When the notification is made, the process in the current cycle ends.

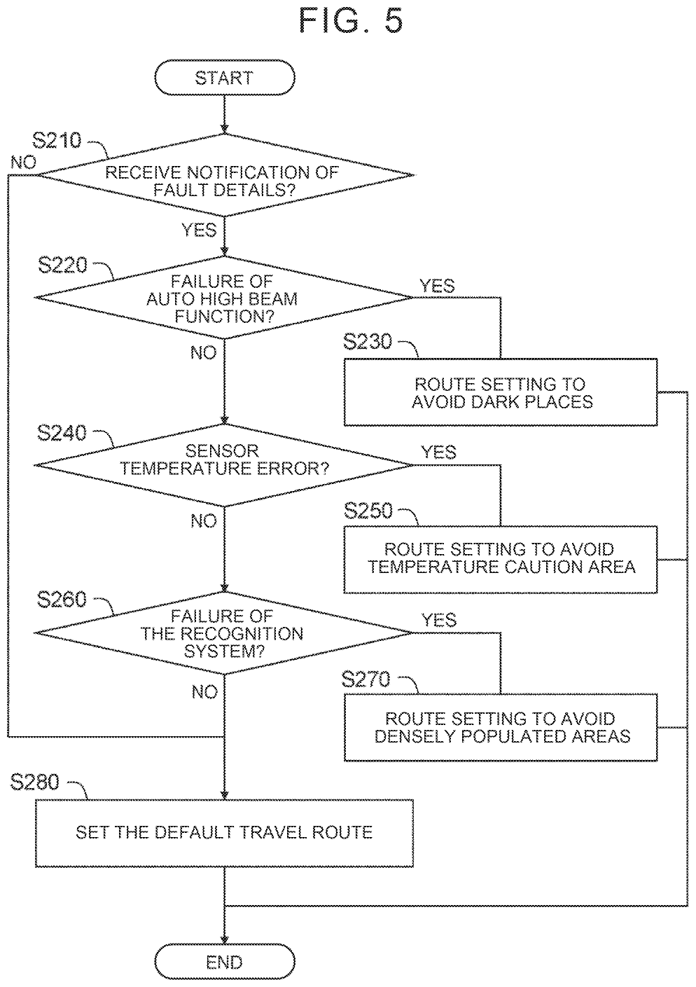

FIG. 5 is a flowchart illustrating an example of processing performed by the travel route setting unit 141 of the autonomous driving control system 100. This process is repeatedly executed in a predetermined control cycle. The processing illustrated in FIG. 5 is realized by the processor 111 executing a program stored in the storage device 112.

In S210, the processor 111 determines whether a notification of the content of the fault has been received from the safety control system 200. If a notification has been received (S210; Yes), the process proceeds to S220. On the other hand, if the notification has not been received (S210; No), the process proceeds to S280.

In S220, the processor 111 determines whether or not the content of the failure notified from the safety control system 200 is a failure of the auto-high beam function. If the content of the failure is a failure of the auto-high beam function (S220; Yes), the process proceeds to S230. On the other hand, when the content of the failure is not the failure of the auto-high beam function (S220; No), the process proceeds to S240.

In S230, the processor 111 sets a travel route of the vehicles 1 to avoid the dark place. At this time, if the traveling route passing through the dark place has already been set, the processor 111 changes the traveling route. When the travel route is set, the process in the current cycle ends.

In S240, the processor 111 determines whether or not the content of the failure notified from the safety control system 200 is a sensor temperature error. If the fault is abnormal sensor temperature (S240; Yes), the process proceeds to S250. On the other hand, when the content of the failure is not a sensor temperature error (S240; No), the process proceeds to S260.

In S250, the processor 111 sets a travel route of the vehicles 1 to avoid the thermal attention area. At this time, when the traveling route passing through the temperature attention region is already set, the processor 111 changes the traveling route. When the travel route is set, the process in the current cycle ends.

In S260, the processor 111 determines whether or not the content of the failure notified from the safety control system 200 is a failure related to the recognition system of the safety control system 200. When the content of the failure is a failure of the recognition system of the safety control system 200 (S260; Yes), the process proceeds to S270. On the other hand, when the content of the failure is not a failure of the recognition system of the safety control system 200 (S260; No), the process proceeds to S280.

In S270, the processor 111 sets a travel route of the vehicles 1 to avoid the densely populated area. At this time, if the traveling route passing through the densely populated area is already set, the processor 111 changes the traveling route. When the travel route is set, the process in the current cycle ends.

In S280, the processor 111 sets the traveling route of the vehicle 1 to a predetermined traveling route. That is, in a case where the contents of the failure are not notified from the safety control system 200, or in a case where the avoidance area for the contents of the notified failure is not set, a predetermined travel route is set. The predetermined traveling route is a traveling route that does not consider the avoidance area. When the travel route is set, the process in the current cycle ends.

As described above, according to the present embodiment, when the contents of the failure are notified from the safety control system 200, the travel route according to the contents of the failure is set in the autonomous driving control system 100. Accordingly, it is possible to improve the continuity of the autonomous driving while giving consideration to the safety of the vehicle 1.

What is claimed is:

1. A vehicle control system comprising:
an autonomous driving control system for controlling autonomous driving of a vehicle; and
a safety control system for performing communication with the autonomous driving control system and stopping the vehicle at a time of failure of the autonomous driving control system or at a time of abnormality of the communication, wherein
when a failure of a part of a function of the safety control system occurs, the safety control system notifies the autonomous driving control system of a content of the failure, and
the autonomous driving control system sets a travel route to a destination during the autonomous driving in accordance with the content of the failure of the part of the function of the safety control system.

2. The vehicle control system according to claim 1, wherein
the autonomous driving control system holds a hazard map indicating an avoidance area to be avoided for each content of the failure of the part of the function of the safety control system, and
the autonomous driving control system sets the travel route to the destination to avoid the avoidance area based on the hazard map and the content of the failure.

3. The vehicle control system according to claim 2, wherein
the failure of the part of the function of the safety control system includes a failure of an auto-high beam function of the vehicle, and
in the hazard map, the avoidance area for the failure of the auto-high beam function includes a dark place in which an average brightness is less than a threshold.

4. The vehicle control system according to claim 2, wherein
the failure of the part of the function of the safety control system includes a sensor temperature abnormality in which a sensor of the safety control system becomes higher than a predetermined temperature, and
in the hazard map, the avoidance area for the sensor temperature abnormality is an area in which a building or a natural object having a height equal to or higher than a predetermined height that blocks sunlight does not exist.

5. The vehicle control system according to claim 2, wherein
the failure of the part of the function of the safety control system includes a failure related to a recognition system of the safety control system, and
in the hazard map, the avoidance area for the failure related to the recognition system includes a densely populated area in which a population density is equal to or greater than a threshold.
